(19) United States
(12) Patent Application Publication
(10) Pub. No.: US 2026/0286638 A1
(43) Pub. Date: Sep. 24, 2026

(54) PILE EXTRACTION DEVICE AND METHOD

(71) Applicants: Cameron BROCHU, Grande Prairie (CA); Colton BROCHU, Grand Prairie (CA)

(72) Inventors: Cameron BROCHU, Grande Prairie (CA); Colton BROCHU, Grand Prairie (CA)

(21) Appl. No.: 19/082,893

(22) Filed: Mar. 18, 2025

(51) Int. Cl. E02D 9/02; F16L 1/028

(52) U.S. Cl. CPC E02D 9/02; F16L 1/028

(57) ABSTRACT

Devices for pulling a pile or pipe from the ground and a methods of using the devices to pull piles or pipes from the ground is disclosed. The device and method uses an outer frame and an inner frame, where the inner frame engages and disengages with the pipe through a slip connector and the inner frame is raised and lowered by a hydraulic ram. This device is attached to and operated through a piece of auxiliary equipment, which can easily transport the device. The extracted pile is removed from the device by tipping the device forward and moving the device backwards and/or the pipe forwards so the pipe is pulled out of the device. The device and method avoid the use of cranes to facilitate the extraction.

### FIELD OF THE INVENTION

The present invention generally relates to devices and methods for the extraction of piles or pipes from the ground.

### BACKGROUND OF THE INVENTION

Piles-typically used to support commercial/residential infrastructures-may be left sticking out of the ground after the site has been discontinued. It is widely acceptable to cut such piles a few inches below the ground so that the pile can be capped, leaving the remaining capped pile in the ground and a potential hazard for the land's future users. It is desirable to have devices and methods of removing piles from the ground as an alternative to capping a pile.

There are existing approaches to removing piles. JP5097192B2 “Connecting Member of Pile Extracting Device” shows a connecting member of a pile extracting device, which rotates a casing with its direction tilted longitudinally or laterally relative to the output shaft of a drive device, and further smoothly supplies a large amount of fluid from the output shaft to the casing. JP3692120B2 “Pile Drawing Device” shows a pile drawing device capable of efficiently drawing a plurality of piles in a narrow construction site by excavating the periphery of a pile to isolate the pile from the ground, and increasing the tension of a wire of a crane.

CN203654289U shows a soil plug compensating pipe pile pulling device for a soil plug compensating pipe pile pull-out construction method in the field of foundation pit support engineering. The main working principle includes that a hollow pipe pile (1) is pulled out by one or combination of a static pile pulling method, a pile periphery stress relief pile pulling method and a vibratory pile pulling method, pressure is exerted by one or combination of a soil plug strength reduction method, a static pressure method, a vibration method and a hammering method, and a soil plug (2) inside the pipe pile (1) cannot be pulled out along with the pipe pile (1) in the pile pulling process. The pile pulling device comprises a soil plug retention device (6), a power device (5) and a pipe pile fixing device (7). The pile pulling device is particularly applicable to pull-out construction of steel pipe piles in foundation pit support, makes the greatest contribution to solve the problems of towing settlement and the like as holes are reserved in soil when the pipe pile is pulled out, and removes the final obstacle for application of the steel pipe piles to foundation pit support.

CN117905063B shows a PHC tubular pile pulling construction method and a pile pulling device for construction thereof, relating to the technical field of pile pulling construction, wherein the PHC tubular pile pulling construction method comprises the following steps: excavating soil so that the head of the PHC pipe pile is exposed for a certain length; vibrating and sinking the pile pulling piece into soil so that the pile pulling piece is positioned at one side of the PHC pipe pile; slowly vibrating the pile pulling piece to pull out soil, and driving the PHC pipe pile to slowly pull out by using friction force; when the PHC pipe pile is pulled out until the bottom is only a certain length and is positioned in the soil body, the PHC pipe pile is pulled out by using a crane. The pile pulling device for PHC pile pulling construction comprises a machine body, a vibrating structure, a clamping structure and a pile pulling piece. The PHC pile pulling device can pull out PHC piles by utilizing vibration friction, and has high pile pulling efficiency and good pile pulling effect.

### SUMMARY OF THE INVENTION

The inventive device avoids the use of cranes and is more portable than devices and methods from the prior art. This allows the present device to be used to extract piles or pipes in situations where existing devices and methods could not be easily used.

In this application, the terms piles and pipes are used interchangeably. A person skilled in the art would know that these devices and methods could be used to extract any cylinder of appropriate size from the ground, and so piles and pipes should be understood to include cylinders that are not pipes.

The device and method uses an outer frame and an inner frame, where the inner frame engages and disengages with the pipe through a slip connector and the inner frame is raised and lowered by one or more hydraulic ram(s). This device is attached to and operated through auxiliary equipment, such as a tractor, which can easily transport the device to areas where existing devices cannot be easily transported. The extracted pipe is removed from the device by tipping the device forward so the outer frame touches the ground, and moving the device backwards of the pipe forwards so the pipe is pulled out of the device. The device and method avoids the use of cranes to facilitate the extraction. In some cases, the pipe is simply pulled out of the ground and then removed from the device. In other cases, the pipe is pulled up, cut, the cut portion of the pipe is removed from the device, the device is reattached to the remaining pipe, and the process is repeated until the pipe is fully pulled from the ground.

In accord with the invention, there is provided a device for extracting pipes from the ground, comprising: an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; and at least one hydraulic ram, connected to the inner frame and configured to raise and lower the inner frame relative to the outer frame.

In an aspect of the invention, the ratio of the vertical height of the outer frame to the vertical height of the inner frame is at least 3:2. In another aspect of the invention, the ratio of the vertical height of the outer frame to the vertical height of the inner frame is at least 2:1. In another aspect of the invention, the difference between the vertical height of the outer frame and the vertical height of the inner frame is at least as large as the stroke of the at least one hydraulic ram. In another aspect of the invention, the back side of the outer frame bears an auxiliary mounting system. In yet another aspect of the invention, the top end of the outer frame has a pile roller.

In accord with the invention, there is provided a device for extracting pipes from the ground, comprising: an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground, the back side of the outer frame bearing an auxiliary mounting system, and the top end of the outer frame has a pile roller; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; at least one hydraulic ram, connected to the inner frame and configured to raise and lower the inner frame relative to the outer frame; and a piece of auxiliary equipment, connected to the auxiliary mounting system, where the piece of auxiliary equipment and the auxiliary mounting system are configured so that the piece of auxiliary equipment can transport the outer frame, and the outer frame can be tipped forward so that the pipe rests upon the pile roller.

In an aspect of the invention the ratio of the vertical height of the outer frame to the vertical height of the inner frame is at least 3:2. In another aspect of the invention, the ratio of the vertical height of the outer frame to the vertical height of the inner frame is at least 2:1. In another aspect of the invention, the difference between the vertical height of the outer frame and the vertical height of the inner frame is at least as large as the stroke of the at least one hydraulic ram.

In accord with the invention, there is provided a method for extracting a pipe with an end sticking out the ground, comprising the steps of: placing an extraction device placed over the pipe, where the extraction device comprises an outer frame in the shape of a rectangular prism that in its longest dimension extends roughly vertically from the ground when the outer frame is placed upon the ground, the outer frame having a vertical height, a front side and an opposite back side and a top end opposite the ground when placed on the ground; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; and at least one hydraulic ram, connected to the inner frame and configured to raise and lower the inner frame relative to the outer frame; so that so that the end of the pipe sticking out the ground intrudes through the hole; engaging the hydraulic ram to lift the inner frame away from the ground, which engages the slip connector with the pipe; using the hydraulic ram to return the inner frame towards the ground, which disengages the slip connector from the pipe; repeating the steps of engaging the hydraulic ram and using the hydraulic ram until the pipe is pulled from the ground and a first end of the pipe extends beyond the top of the outer frame; tipping the outer frame towards the ground so that a first edge of the top end of the front side of the outer frame touches the ground; disengaging the slip connector from the pipe; and pulling the outer frame along the ground or pulling the pipe so that the pipe exits the outer frame.

In an aspect of the invention, the back side of the outer frame bears an auxiliary mounting system, and the top end of the outer frame has a pile roller; and the step of tipping the outer frame towards the ground, further comprises attaching a piece of auxiliary equipment to the auxiliary mounting system, and the piece of auxiliary equipment tips the outer frame towards the ground so that the pipe rests on the pile roller. In another aspect of the invention, the difference between the vertical height of the outer frame and the vertical height of the inner frame is at least as large as the stroke of the at least one hydraulic ram. In another aspect of the invention, the ratio of the vertical height of the outer frame to the vertical height of the inner frame is at least 3:2. In another aspect of the invention, the ratio of the vertical height of the outer frame to the vertical height of the inner frame is at least 2:1. In another aspect of the invention, the method further comprises the step of lowering the ground around the pipe.

In accord with the invention, there is provided a method for extracting a pipe with an end sticking out the ground, comprising the steps of: placing an extraction device placed over the pipe, where the extraction device comprises an outer frame in the shape of a rectangular prism that in its longest dimension extends roughly vertically from the ground when the outer frame is placed on the ground, the outer frame having a vertical height, a front side and an opposite back side and a top end opposite the ground when placed on the ground; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; and at least one hydraulic ram, connected to the inner frame and configured to raise and lower the inner frame relative to the outer frame; so that so that the end of the pipe sticking out the ground intrudes through the hole; engaging the hydraulic ram to lift the inner frame away from the ground, which engages the slip connector with the pipe; using the hydraulic ram to return the inner frame towards the ground, which disengages the slip connector from the pipe; repeating the steps of engaging the hydraulic ram and using the hydraulic ram until a first end of the pipe extends beyond the top of the outer frame; cutting the pipe; tipping the outer frame towards the ground so that a first edge of the top of the front side of the outer frame touches the ground; disengaging the slip connector from the pipe; and pulling the outer frame along the ground or pulling the pipe so that the pipe exits the outer frame.

In an aspect of the invention, the back side of the outer frame bears an auxiliary mounting system, and the top end of the outer frame has a pile roller; and the step of tipping the outer frame towards the ground, further comprises attaching a piece of auxiliary equipment to the auxiliary mounting system, and the piece of auxiliary equipment tips the outer frame towards the ground so that the pipe rests on the pile roller. In another aspect of the invention, the difference between the vertical height of the outer frame and the vertical height of the inner frame is at least as large as the stroke of the at least one hydraulic ram.

In accord with the invention, there is provided a method for extracting a pipe with an end sticking out the ground, comprising the steps of: placing an extraction device placed over the pipe, where the extraction device comprises an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground the back side of the outer frame bearing an auxiliary mounting system, and the top end of the outer frame has a pile roller; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; at least one hydraulic ram, connected to the inner frame and configured to raise and lower the inner frame relative to the outer frame; and a piece of auxiliary equipment, connected to the auxiliary mounting system, where the piece of auxiliary equipment and the auxiliary mounting system are configured so that the piece of auxiliary equipment can transport the outer frame, and the outer frame can be tipped forward so that a first edge at the top end of the outer frame rests upon the ground; so that the end of the pipe sticking out the ground intrudes through the hole; engaging the hydraulic ram to lift the inner frame away from the ground, which engages the slip connector with the pipe; using the hydraulic ram to return the inner frame towards the ground, which disengages the slip connector from the pipe; repeating the steps of engaging the hydraulic ram and using the hydraulic ram until the pipe is pulled from the ground and a first end of the pipe extends beyond the top of the outer frame; tipping the outer frame towards the ground so that the first edge touches the ground and the pipe rests on the pile roller; disengaging the slip connector from the pipe; and pulling the outer frame along the ground or pulling the pipe so that the pipe exits the outer frame.

In accord with the invention, there is provided a method for extracting a pipe with an end sticking out the ground, comprising the steps of: placing an extraction device placed over the pipe, where the extraction device comprises an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground, the back side of the outer frame bearing an auxiliary mounting system, and the top end of the outer frame has a pile roller; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; at least one hydraulic ram, connected to the inner frame and configured to raise and lower the inner frame relative to the outer frame; and a piece of auxiliary equipment, connected to the auxiliary mounting system, where the piece of auxiliary equipment and the auxiliary mounting system are configured so that the piece of auxiliary equipment can transport the outer frame, and the outer frame can be tipped forward so that a first edge of the top end of the outer frame rests upon the ground; so that so that the end of the pipe sticking out the ground intrudes through the hole; engaging the hydraulic ram to lift the inner frame away from the ground, which engages the slip connector with the pipe; using the hydraulic ram to return the inner frame towards the ground, which disengages the slip connector from the pipe; repeating the steps of engaging the hydraulic ram and using the hydraulic ram until a first end of the pipe extends beyond the top of the outer frame; cutting the pipe; tipping the outer frame towards the ground so that the first edge of the outer frame touches the ground and the pipe rests on the pile roller; disengaging the slip connector from the pipe; and pulling the outer frame along the ground or pulling the pipe so that the pipe exits the outer frame. In an aspect of the invention, the method further comprises the step of lowering the ground around the pipe.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a front view of the pile extraction device;

FIG. 2 is a side view of the pile extraction device;

FIG. 3 is a top view of the inner frame and base plate of the pile extraction device;

FIG. 4 is a top view of the base plate of the inner frame of the pile extraction device;

FIG. 5 is a top view of the inner frame and outer frame and inner frame base plate of the pile extraction device.

FIG. 6 is a side view of the pile extraction device with the inner frame in its lowered position connected to a piece of auxiliary equipment with a pipe inside;

FIG. 7 is a side view of the pile extraction device with the inner frame in a raised position connected to a piece of auxiliary equipment and with a pipe extending from the device; and

FIG. 8 is a side view of the pile extraction device with a pipe and the device being tipped forward so that the pipe rests on the pile roller and the outer frame rests on the ground.

FIG. 9 is a top view of the outer frame, showing the positioning of the pile roller, front extension bars and outer frame top bar.

FIG. 10 is a perspective view of part of the pile extraction device, illustrating the positioning of the inner frame, outer frame and hydraulic rams.

### DESCRIPTION OF NUMBERS

101—outer frame
103—inner frame
105—outer frame top bar
106—outer frame sidebar
107—pile roller
108—roller attachments
109—hydraulic ram
111—hydraulic ram
113—connecter (hydraulic ram mount)
115—slip connection
117—hole (inner frame (103))
118—inner frame gussets
119—inner frame base plate
119A—corner extensions of the inner frame base plate
120—corner post (outer frame (101))
121—lower inner frame support plate
122—corner post (inner frame (103))
124—guidance channels
126—auxiliary mounting system
127—outer frame base plate
128—hole (outer frame (101))
129—slip releasing bar
130—outer frame gussets
131—pressure indicators
132—upper inner frame support plate
300—pile or pipe
301—auxiliary equipment
303—ground
400—front extension bars

### DETAILED DESCRIPTION OF THE INVENTION

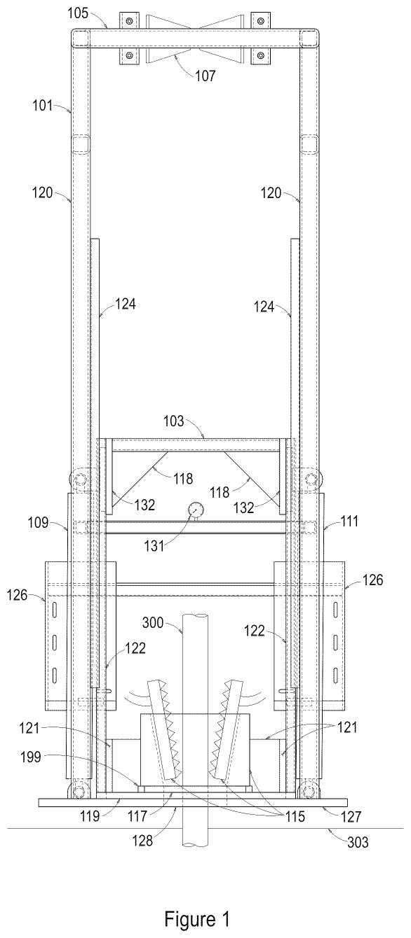

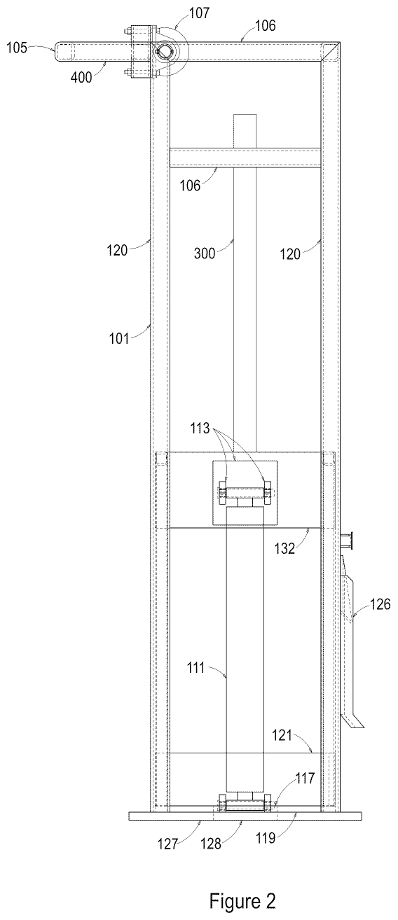

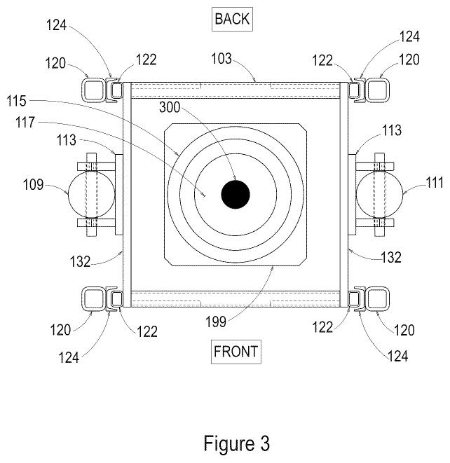

FIG. 1 is a front view of the pile extraction device, and FIG. 2 is a side view of the pile extraction device. Turning to FIGS. 1 and 2, there is an outer frame 101 of the shape of a rectangular prism and an inner frame 103 also in the shape of a rectangular prism. The outer frame 101 has a top bar 105, which in the front is extended outwards by front extension bars 400. In a preferred embodiment, outer frame 101 includes a pile roller or wheel 107. Outer frame 101 also includes a hole 128 (better seen in FIG. 3) at the bottom of the outer frame base plate 127. For strength, the outer frame 101 optionally has a sidebar 106 and optionally has outer frame gussets. In use, outer frame base plate 127 is placed on the ground 303, and pile roller 107 is at the top end of outer frame 101 opposite the ground 303.

There are two hydraulic rams 109 and 111, which are connected to the inner frame 103 by suitably strong connectors 113 (better seen in FIG. 3). There is a slip connection 115 which is attached to the bottom of the inner frame base plate 119.

In a preferred embodiment, the pile extraction device uses two hydraulic rams. However, it is possible to vary the number of hydraulic rams, including just one and also three or more hydraulic rams.

The inner frame 103 has an inner frame base plate 119 attached to the bottom of inner frame 103. FIG. 3 is a top view of the inner frame and base plate of the pile extraction device. Turning to FIG. 3, there is a slip connection 115 which is circular and surrounds a round hole 117, which is cut into the inner frame base plate 119 which is part of the inner frame 103. Plate 199 is an (optional but preferred) plate that supports the slip connection 115. For strength, the inner frame 103 also optionally has a lower inner frame support plate 121 and optionally has inner frame gussets 118. In a preferred embodiment, the inner frame 103 also has an upper inner frame support plate 132.

The outer frame 101 also is attached at the bottom to an outer frame base plate 127, and a hole 128 which is bored into the bottom of the outer frame base plate 127 matching with hole 117.

Turning to FIG. 2, there is an auxiliary mounting system 126 by which the pile extraction device can be attached to a piece of auxiliary equipment. “Auxiliary equipment” as used in this application can be many different vehicles, including but not limited to a skid steer or excavator or a tractor. Generally, auxiliary equipment can be any vehicle that, when connected to the pile extraction device via auxiliary mounting system 126, is capable of moving the pile extraction device and also capable of tipping the pile extraction device forward, as described below. In a preferred embodiment, the auxiliary equipment also has the capability of supplying hydraulic pressure to the one or more hydraulic ram(s) 109 and 111.

FIG. 3 is a top view of the inner frame and base plate of the pile extraction device. Turning to FIG. 3, there is a slip connection 115 which is circular and surrounds a round hole 117, which is cut into a bottom plate 119 which is part of the inner frame 103 and a hole 128 which is bored into the bottom of the outer frame base plate 127 matching with hole 117.

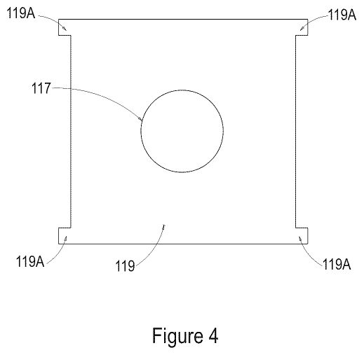

FIG. 4 is is a top view of the base plate 119 of the inner frame 103 of the pile extraction device, but with a hole 117 as discussed above. For greater stability, the base plate 119 includes corner extensions 119A that are sized to fit in guidance channels 124 (as described below).

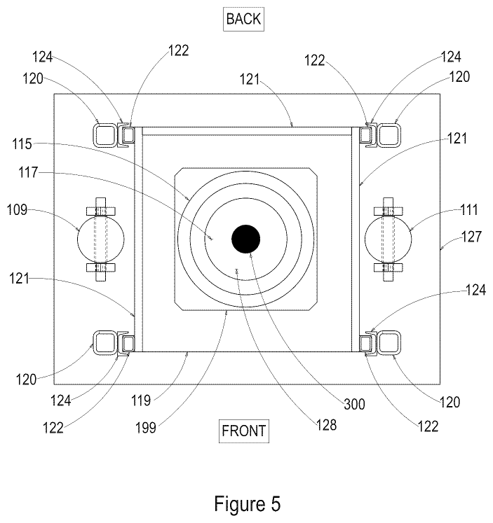

FIG. 5 is a top view of the inner frame and outer frame and inner frame base plate of the pile extraction device. Turning to FIG. 5, The outer frame 101 has corner posts 120, which include guidance channels 124. Outer frame 101 is connected to outer frame base plate 127. The inner frame 103 has corner posts 122 which are located within the guidance channels 124 of outer frame 101. The inner frame 103 can slide up and down the outer frame 101 suitably because of the guidance channels 124, holding it inside the outer frame 101 by the inner frame 103's corner posts 122 being secured within the guidance channels 124; ensuring that the inner frame stays parallel and straight within the outer frame 101.

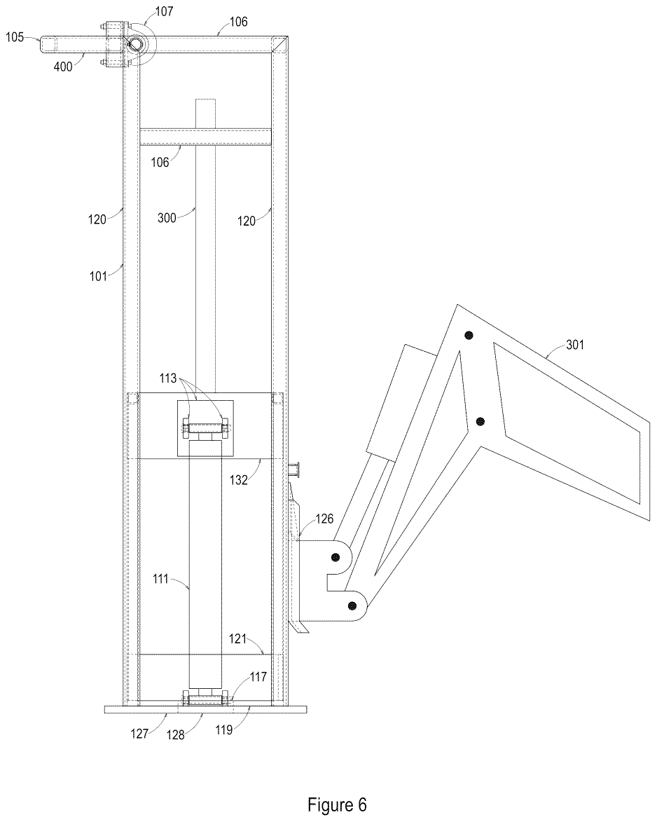

The use of the inventive device to extract a pipe from the ground is illustrated in FIGS. 6, 7 and 8.

FIG. 6 is a side view of the pile extraction device with a pipe connected to a piece of auxiliary equipment. Turning to FIG. 6, there is an auxiliary mounting system 126 attached to the lower half of the back side of outer frame 101. The auxiliary mounting system 126 is operationally and manipulably attached to a piece of auxiliary equipment via arm 301 of the piece of auxiliary equipment. In FIG. 6, the inner frame 103 is in a lowered position, and there is a pipe 300 to be extracted.

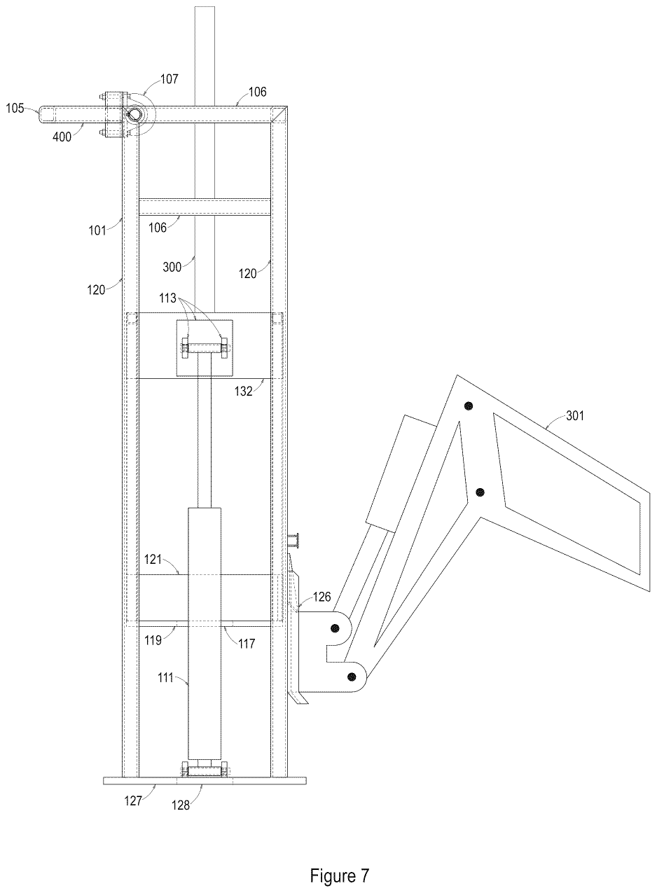

FIG. 7 is a side view of the pile extraction device with a pipe and the inner frame in a raised position connected to a piece of auxiliary equipment. Turning to FIG. 7, the auxiliary mounting system 126 is operationally and manipulably attached to a piece of auxiliary equipment via arm 301 of the piece of auxiliary equipment. In FIG. 7, the inner frame 103 and upper inner frame support plate 132 are in a raised position, and the top end of pipe 300 is above the top of outer frame 101.

In use the pile extraction device is placed so that so that the end of the pipe sticking out the ground intrudes through the holes 117 and 128. In a preferred embodiment, the pile extraction device is carried and placed by the piece of auxiliary equipment which is connected to the outer frame 101 by auxiliary mounting system 126 and arm 301; however, as a general matter the pile extraction device can be moved and maneuvered by other means.

Once the pile extraction device is in position, hydraulic ram 109 and 111 are engaged to lift the inner frame 103 away from the ground, which engages the slip connector 115 with the pipe 300. This pulls the pipe 300 up out of the ground. The hydraulic rams 109 and 111 then lower the inner frame 103 towards the ground, which disengages the slip connector 115 from the pipe 300. By repeated raising and lowering the inner frame 103 (and so repeatedly engaging and disengaging slip connector 115), the pipe 300 is pulled from the ground.

In a preferred embodiment, the hydraulic rams 109 and 111 are operably connected to the auxiliary equipment (which is connected to the outer frame 101 by auxiliary mounting system 126 and arm 301) so that the operator of the auxiliary equipment controls the hydraulic rams 109 and 111 by providing hydraulic pressure to the hydraulic rams 109 and 111 from the auxiliary equipment.

In a preferred embodiment, the operator of the auxiliary equipment will monitor the pressure indicator 131, which will be configured to indicate the forces present on both the pile 300 and the inner frame 103, which will be used to ensure a safe work environment.

Eventually, the top end of pipe 300 is raised clear of the top of the outer frame 101, as illustrated in FIG. 7.

At this point, the pipe 300 is ready for removal from the pile extraction device. If the entire pipe 300 has not been pulled out of the ground, then the device is operated until a desirable length of pipe 300 extends beyond the top of the outer frame, and then the pipe 300 is cut. In a preferred embodiment, the pipe 300 is cut towards the bottom of the pile extraction device.

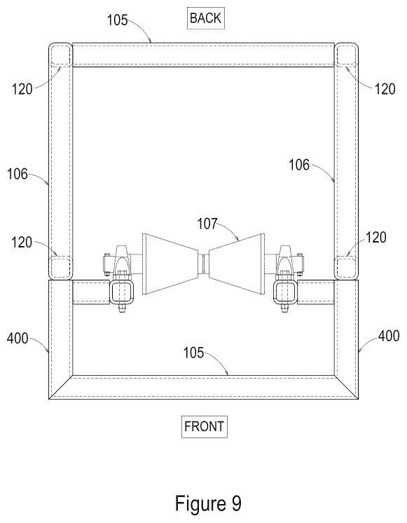

FIG. 9 is a top view of the outer frame, showing, front extension bars and outer frame top bar and optional but preferred pile roller. Turning to FIG. 9, there is pile roller 107, front extension bars 400 and outer frame top bar 105. In a preferred embodiment, pile roller 107 is attached to the top end of the outer frame-while FIG. 9 shows one implementation of this via roller attachments 108, other embodiments are possible.

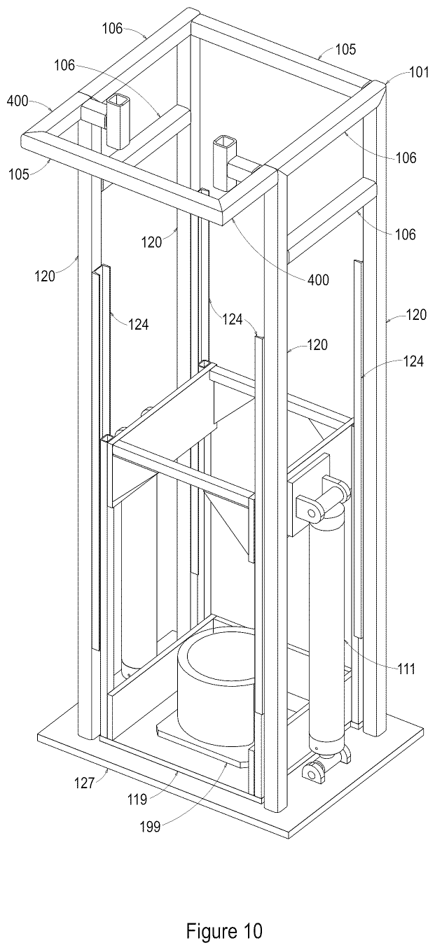

FIG. 10 is a perspective view of part of the pile extraction device, illustrating the positioning of the inner frame, outer frame and hydraulic rams. Turning to FIG. 10, there are front extension arms 400 and outer frame bar 105, outer frame sidebars 106, corner posts 120 (of the outer frame 101), guidance channels 124, hydraulic ram 111, inner frame base plate 119, and outer frame base plate 127.

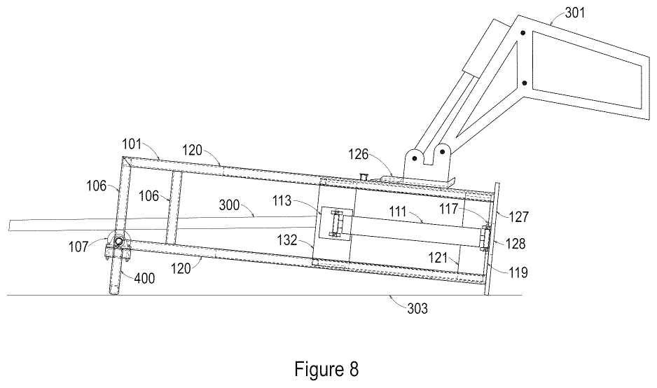

FIG. 8 illustrates the removal of the pipe from the pile extraction device. FIG. 8 is a side view of the pile extraction device with a pipe and the device being tipped forward so that the front extension arms 400 and outer frame bar 105 rest on the ground. Turning to FIG. 8, the pipe 300 is removed from the pile extraction device by tipping the outer frame towards the ground 303 so that front extension arms 400 and outer frame bar 105 touches the ground 303 and the end of the pipe 300 extending beyond the outer frame 101 rests on pile roller 107. After first ensuring that the slip connector 115 is disengaged from the pipe 300, pipe 300 is secured, and the pile extraction device is then pulled backwards and/or pipe 300 is pulled forward so that pipe 300 is pulled out from the pile extraction device.

In a preferred embodiment, the pile extraction device is tipped, and then moved backwards, by the piece of auxiliary equipment which is connected to the outer frame 101 by auxiliary mounting system 126 and arm 301; however, as a general matter the pile extraction device can be tipped and pulled by other means.

In a preferred embodiment, the pile extraction device can be used to extract piles without cutting that are around 1″ to around 10″ in diameter and a maximum length of around 30 ft. In a preferred embodiment, the outer frame is around 48 inches wide when viewed from the front and 36 inches wide when viewed from the side, so that the base of the outer frame is around 48 inches by around 36 inches; and the inner frame is around 30 inches wide when viewed from the front and 29 inches wide when viewed from the side, so that the base of the inner frame is around 30 inches by around 29 inches, and the total height of the pile extraction device/outer frame is around 120 inches and the total height of the inner frame is around 55 inches, and the stroke of the hydraulic rams is around 45 inches (nominally 48 inches). Modified pile extraction devices can be made for additional lengths and/or sizes of piles depending on the auxiliary equipment available and the given needs or parameters of the extraction. In this paragraph, around means plus or minus 10%.

Preferably, the difference between the height of the outer frame and the height of the inner frame must be long enough to accommodate the stroke of the hydraulic ram(s). There is some advantage to making the outer frame higher (in terms of distance from the ground when positioned around a pile), but at some point the device becomes unwieldy, more difficult to move around and more unstable (i.e. prone to uncontrolled or unintentional tipping). The effective maximum height of the outer frame is also dependent upon the technical specifications of the auxiliary equipment. In one preferred embodiment, the ratio of the height of the outer frame to the height of the inner frame is at least 2:1. In another preferred embodiment, the ratio of the height of the outer frame to the height of the inner frame is at least 3:2.

The back to front dimension of the base of the outer frame is limited by the desire to be able to tip the device forward and not hit the auxiliary equipment. The size (or area) of the bottom plate at the base of the outer frame does have a minimum size in that it has to be large enough to accommodate the diameter of the pile to be extracted plus the slip connector. However, the pile extraction device will be more stable in use with a larger bottom plate at the base of the outer frame. If necessary (for example, if the ground is soggy or slippery), the device can be further stabilized by placing the device on a constructed base, such as a constructed wooden base.

In order for the device to work well, the pile does have to be exposed above the ground to the extent so that the device can be placed over the pile and the pile grasped by the slip connections. If necessary, the ground around the pile can be lowered so that the device can be used.

What is claimed is:

1. A device for extracting pipes from the ground, comprising:
an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground;
an inner frame positioned within the outer frame in the shape of a rectangular prism and having a vertical height, and slidably connected to the outer frame so that the inner frame can slide up from the ground and back down towards the ground when the outer frame is placed on the ground;
the inner frame having a plate at the bottom of the inner frame with a hole pierced therethrough of sufficient diameter to surround a pipe;
a slip connector located at the hole and attached to the inner frame and being configured to detachably engage with a pipe when the pipe intrudes through the hole; and
at least one hydraulic ram, connected to the inner frame and configured to raise and lower the inner frame relative to the outer frame.

2. The device of claim 1, where the ratio of the vertical height of the outer frame to the vertical height of the inner frame is at least 3:2.

3. The device of claim 1, where the ratio of the vertical height of the outer frame to the vertical height of the inner frame is at least 2:1.

4. The device of claim 1, where the difference between the vertical height of the outer frame and the vertical height of the inner frame is at least as large as the stroke of the at least one hydraulic ram.

5. The device of claim 4, where the back side of the outer frame bears an auxiliary mounting system.

6. The device of claim 5, where the top end of the outer frame has a pile roller.

7. A device for extracting pipes from the ground, comprising:
an outer frame in the shape of a rectangular prism that in its longest dimension extends roughly vertically from the ground when placed on the ground, the outer frame having a vertical height, a front side and an opposite back side and a top end opposite the ground when the outer frame is placed on the ground, the back side of the outer frame bearing an auxiliary mounting system, and the top end of the outer frame has a pile roller;
an inner frame positioned within the outer frame in the shape of a rectangular prism and having a vertical height, and slidably connected to the outer frame so that the inner frame can slide up from the ground and back down towards the ground when the outer frame is placed on the ground;
the inner frame having a plate at the bottom of the inner frame with a hole pierced therethrough of sufficient diameter to surround a pipe;
a slip connector located at the hole and attached to the inner frame and being configured to detachably engage with a pipe when the pipe intrudes through the hole;
at least one hydraulic ram, connected to the inner frame and configured to raise and lower the inner frame relative to the outer frame; and
a piece of auxiliary equipment, connected to the auxiliary mounting system, where the piece of auxiliary equipment and the auxiliary mounting system are configured so that the piece of auxiliary equipment can transport the outer frame, and the outer frame can be tipped forward so that the pipe rests upon the pile roller.

8. The device of claim 7, where the ratio of the vertical height of the outer frame to the vertical height of the inner frame is at least 3:2.

9. The device of claim 7, where the ratio of the vertical height of the outer frame to the vertical height of the inner frame is at least 2:1.

10. The device of claim 7, where the difference between the vertical height of the outer frame and the vertical height of the inner frame is at least as large as the stroke of the at least one hydraulic ram.

11. A method for extracting a pipe with an end sticking out the ground, comprising the steps of:
placing an extraction device placed over the pipe,
where the extraction device comprises an outer frame in the shape of a rectangular prism that in its longest dimension extends roughly vertically from the ground when the outer frame is placed upon the ground, the outer frame having a vertical height, a front side and an opposite back side and a top end opposite the ground when placed on the ground; an inner frame positioned within the outer frame in the shape of a rectangular prism and having a vertical height, and slidably connected to the outer frame so that the inner frame can slide up from the ground and back down towards the ground when the outer frame is placed on the ground; the inner frame having a plate at the bottom of the inner frame with a hole pierced therethrough of sufficient diameter to surround a pipe; a slip connector located at the hole and attached to the inner frame and being configured to detachably engage with a pipe when the pipe intrudes through the hole; and at least one hydraulic ram, connected to the inner frame and configured to raise and lower the inner frame relative to the outer frame;
so that so that the end of the pipe sticking out the ground intrudes through the hole;
engaging the hydraulic ram to lift the inner frame away from the ground, which engages the slip connector with the pipe;
using the hydraulic ram to return the inner frame towards the ground, which disengages the slip connector from the pipe;
repeating the steps of engaging the hydraulic ram and using the hydraulic ram until the pipe is pulled from the ground and a first end of the pipe extends beyond the top of the outer frame;
tipping the outer frame towards the ground so that a first edge of the top end of the front side of the outer frame touches the ground;
disengaging the slip connector from the pipe; and
pulling the outer frame along the ground or pulling the pipe so that the pipe exits the outer frame.

12. The method of claim 11, where the back side of the outer frame bears an auxiliary mounting system, and the top end of the outer frame has a pile roller; and the step of tipping the outer frame towards the ground, further comprises attaching a piece of auxiliary equipment to the auxiliary mounting system, and the piece of auxiliary equipment tips the outer frame towards the ground so that the pipe rests on the pile roller.

13. The method of claim 12, where the difference between the vertical height of the outer frame and the vertical height of the inner frame is at least as large as the stroke of the at least one hydraulic ram.

14. The method of claim 13, where the ratio of the vertical height of the outer frame to the vertical height of the inner frame is at least 3:2.

15. The method of claim 13, where the ratio of the vertical height of the outer frame to the vertical height of the inner frame is at least 2:1.

16. The method of claim 13, further comprising the step of lowering the ground around the pipe.
